(19) United States
(12) Patent Application Publication
(10) Pub. No.: US 2025/0020772 A1
(43) Pub. Date: Jan. 16, 2025

(54) RICE-CROP INTENSITY IDENTIFICATION METHOD BASED ON RADAR TIME SERIES OBSERVATION AND TEMPERATURE ANALYSIS

(71) Applicants: UNIVERSITY OF ELECTRONIC SCIENCE AND TECHNOLOGY OF CHINA, Chengdu (CN); Yangtze Delta Region Institute (Huzhou), University of Electronic Science and Technology of China, Huzhou (CN)

(72) Inventors: Shihua Li, Chengdu (CN); Ze He, Chengdu (CN); Fugui Luo, Huzhou (CN); Minfeng Xing, Huzhou (CN)

(21) Appl. No.: 18/517,235

(22) Filed: Nov. 22, 2023

(30) Foreign Application Priority Data
Jul. 11, 2023 (CN) 2023108458892

(51) Int. Cl. G01S 7/41; G01S 13/88

(52) U.S. Cl. CPC G01S 7/41; G01S 13/88

(57) ABSTRACT

A rice-crop intensity identification method based on radar time series observation and temperature analysis is provided. Capturing of diversified periodic characteristics of time series backscatter and detection of backscatter troughs are achieved through time series reconstruction and trough identification; potential phenological phases corresponding to the backscatter troughs are determined through potential rice phenological phase estimation; and through temperature limitation of rice phenological phase, temperature suitability of potential rice phenological phases is evaluated, a backscatter trough that does not satisfy a temperature condition is removed by combining a rice growth mechanism and a regulation of rice-crop intensity, thereby realizing the identification of the rice troughs and the correction of the overestimation of the rice-crop intensity, and finally realizing the identification of rice-crop intensity.

### TECHNICAL FIELD

The disclosure relates to the technical field of spaceborne radar data processing and remote sensing mapping, and particularly to a rice-crop intensity identification method based on radar time series observation and temperature analysis.

### BACKGROUND

Rice-crop intensity refers to the number of rice planting cycles in a given year within a rice field. Depending on agricultural practices, rice fields may be used for single-season rice, double-season rice, or triple-season rice cultivation. Accurately identifying rice-crop intensity holds significant importance for estimating grain yields and formulating agricultural policies. Remote sensing observations serve as a crucial method for large-scale rice-crop intensity identification. Continuous monitoring of rice cultivation can be achieved through long-term observations of rice fields, with optical satellites serving as the primary data source. However, adverse weather conditions, such as cloudiness or rainfall during the rice-growing season, can disrupt optical imaging. As a result, high-resolution rice-crop intensity identification using optical satellite data is only viable in limited areas, while large-scale identification relies on low-resolution optical satellite data, posing challenges for ensuring accuracy.

Radar technology is immune to meteorological interference, making satellites equipped with radar increasingly valuable as an alternative data source for identifying rice-crop intensity. Long-term radar observations yield time series backscatter data from rice fields, which, when analyzed, can provide insights into the dynamic changes in the physical and chemical characteristics of rice plants and soil under varying rice-crop intensities. However, large-scale rice-crop intensity identification based on time series backscatter data faces three unresolved challenges: the diversity of time series backscatter data due to complex agricultural practices, the ambiguity in backscatter characteristics between rice and non-rice objects due to lack of prior phenological information, and the overestimation of rice-crop intensity due to unexpected land change processes. These three challenges significantly impede the application of radar data in large-scale rice-crop intensity identification.

### SUMMARY

In view of the above problems or deficiencies, and to address the three challenges, namely the diversity of time series backscatter data, the ambiguity in backscatter characteristics between rice and non-rice objects, and the overestimation of rice-crop intensity, this disclosure introduces a rice-crop intensity identification method based on radar time series observation and temperature analysis. The method involves capturing periodic features and identifying temporal troughs within the time series backscatter data through time series reconstruction and trough identification. The timing of rice phenology, corresponding to each trough, is determined through potential rice phenological phase estimation. Subsequently, a temperature suitability assessment for these potential rice phenological phases is conducted using a temperature limitation procedure. Any trough that fails to meet the temperature limitation criteria is excluded. This process facilitates the identification of rice troughs and the correction of overestimations in rice-crop intensity, ultimately allowing for accurate rice-crop intensity identification.

An embodiment of the disclosure provides a rice-crop intensity identification method based on radar time series observation and temperature analysis, which includes the following steps:
S1, time series reconstruction and trough identification:
   obtaining annual radar time series backscatter data of a target area in VH (vertical transmission and horizontal reception) polarization;
   constructing time series backscatter S[t] based on the annual radar VH polarization time series backscatter data, where/represents a normalized Julian date, and its value ranges from 0 to 1;
   performing time series harmonic fitting by using a formula 1 to obtain reconstructed time series backscatter:

$$S [ t ] = a + {\sum }_{i = 1}^{3} {A}_{i} cos [ 2 π it - {φ}_{i} ] , \qquad ( formula 1 )$$

where a is a constant term representing the average value of the time series backscatter; i takes values 1, 2, and 3 successively, indicating the order of a cosine term; Aᵢ represents the amplitude of the i-th order cosine term, and φᵢ represents the phase of the i-th order cosine term; The process of performing time series harmonic fitting using Formula 1 to obtain the reconstructed time series backscatter S[t] includes: obtaining values of a, Aᵢ, and φᵢ by using least square fitting, and substituting the values of a, Aᵢ and φᵢ into the formula 1 to obtain the reconstructed time series backscatter S[t];
obtaining the first-order difference S′[t] of the reconstructed time series backscatter S[t] using a formula 2:

$${S}^{′} [ t ] = {\sum }_{i = 1}^{3} - 2 π {iA}_{i} sin [ 2 π it - {φ}_{i} ] ; \qquad ( formula 2 )$$

calculating the values of S[t] and S′[t] for the time t in the range from 0 to 1 with a step size of 0.01. when S′[t−1]<0, S′[t+1]>0, and S[t]<0.02, the time t corresponds to the occurrence of a backscatter trough. The actual Julian date d corresponding to t can be calculated as d=365t, where the unit of d is in days;
S2, potential rice phenological phase estimation:
   The key phenological phases include the seedling phase, transplanting phase, vegetative phase, reproductive phase, and maturation phase, denoted as D_{S}, D_{T}, D_{V}, D_{R} and D_{M}, respectively; obtaining annual daily averaged temperature data of the target area; calculating the duration of annual cold period P_{C} of the target area. P_{C} is defined as the period with temperatures below 10 degrees Celsius (° C.), and the unit of P_{C} is in days; For the target area, when P_{C}≠0, and d>240, determining that d corresponds to D_{R}, and in this case, determining that D_{S}=d−90, D_{T}=d−60, D_{V}=d−30, D_{R}=d, and D_{M}=d+30; and when P_{C}=0 or d≤240, determining that d corresponds to D_{T}, and in this case, determining D_{S}=d−30, D_{T}=d, D_{V}=d+30, D_{R}=d+60, and D_{M}1=d+90; and
S3, temperature limitation of rice phenological phase:
   Obtaining the temperature E_{S} on date D_{S}, temperature E_{T} on date D_{T}, temperature E_{V} on date D_{V}, temperature E_{R} on date D_{R}, and temperature E_{M} on date D_{M}, respectively;
   for a target backscatter trough, when E_{S}>10° C., E_{T}>10° C., E_{V}>18° C., E_{R}>18° C., and E_{M}>10° C., determining the trough as a valid trough, otherwise determining the trough as an invalid trough and removing the invalid trough; counting the number N of valid troughs;
   determining the maximum rice-crop intensity suitability S for the target area according to the following regulation:

$$\{ \begin{matrix}if Pc = 0 , then S = 3 ; \\ if 0 < Pc \leq 120 , then S = 2 ; \\ if 120 < Pc \leq 240 , then S = 1 ; \\ if Pc > 2 \; 40 , then S = 0 .\end{matrix} ;$$

and
for the target area, when N>S, determining that there is overestimation of rice-crop intensity; and calculating the sum values Sum of temperatures on the five phenological phases for each valid trough: Sum=E_{S}+E_{T}+E_{V}+E_{R}+E_{M}; and removing troughs with lower Sum, the number of troughs to be removed is N−S; and determining the remaining troughs as a rice trough and counting the number of rice troughs of the target area (i.e., rice-crop intensity of the target area); and when N≤S, determining the number N of valid troughs as the number of rice troughs of the target area (i.e., rice-crop intensity of the target area); and
S4, identification of rice-crop intensity:
   obtaining digital elevation data of the target area, and extracting altitude and slope information of the target area from the digital elevation data; obtaining land use product of the target area, and extracting cropland distribution information from the land use product; and performing rice-crop intensity identification of the target area based on the altitude, the slope, the cropland distribution information, and the number of rice troughs of the target area.

In an embodiment, in S4, a threshold condition for the extracting the altitude and the slope information is reserving the cropland distribution with an altitude below 1000 meters (m) and a slope below 5°.

In an embodiment, performing rice-crop intensity identification of the target area based on the altitude, the slope, the cropland distribution information, and the number of rice troughs of the target area further includes: presenting the number of rice troughs of the target area (i.e., rice-crop intensity of the target area) based on the altitude, the slope, and the cropland distribution information.

In an embodiment, the method further includes estimating a yield of the target area based on the number of rice troughs of the target area (i.e., rice-crop intensity of the target area), and thereby, agricultural management personnel will craft agricultural policies grounded in the yield of the target area.

In an embodiment, the rice-crop intensity identification method based on radar time series observation and temperature analysis is implemented by a rice-crop intensity identification device including a processor and a memory with a rice-crop intensity identification application stored therein. The rice-crop intensity identification application, when executed by the processor, is configured to implement the rice-crop intensity identification method based on radar time series observation and temperature analysis and is further configured to send, over the Internet, the number of rice troughs of the target area (i.e., rice-crop intensity of the target area) to a mobile terminal of agricultural management personnel. An application installed in the mobile terminal is configured to receive the number of rice troughs of the target area, and display the number of rice troughs of the target area on the mobile terminal to assist the agricultural management personnel to estimate a yield of the target area and formulate agricultural policy based on the yield of the target area.

Principles of S1-S4 are as Follows.

A principle of the time series reconstruction and trough identification is as follows. The coherence of radar signals, irregular rainfall, and various agricultural management practices in the field, such as irrigation, drainage, fertilization, and weeding, can all introduce random noise into the time series backscatter data. Moreover, differences in rice-crop intensity and agricultural phenology across fields can result in diverse and complex patterns in the time series backscatter. Given that rice can be planted at most three times a year, the time series reconstruction method based on the harmonic decomposition using the three-order cosine components is capable of effectively mitigating noise interference while preserving the dominant periodicity of the time series backscatter. The most significant features in the time series backscatter data are the crests and troughs. Crests may be influenced by a multitude of factors, including rice growth, changes in soil moisture, and alterations in field roughness. These crests prove challenging to use as reliable indicators of rice planting cycles. On the other hand, low-backscatter troughs (those measuring less than 0.02) are closely associated with field irrigation during rice planting. After applying three-order cosine harmonic fitting, a single trough lasting over 30 days can be identified in each rice planting cycle, making these low-backscatter troughs a dependable indicator of rice planting cycles.

A principle of potential rice phenological phase estimation is as follows. A complete rice planting cycle encompasses five phenological phases: the seedling phase, transplanting phase, vegetative phase, reproductive phase, and maturation phase, with each phase lasting approximately 30 days. During the initial 30 days (seedling phase), the rice typically remains in a specific seedling raising field, while the subsequent phases (120 days in total) are completed in a larger-scale field where crops are planted. A backscatter trough is closely associated with field irrigation during rice planting. Typically, the most prominent backscatter trough in a single rice planting cycle is caused by field irrigation during the rice transplanting phase. However, in cases where the temperature is not always above 10° C. in the year, and rice transplantation occurs after July, farmers may implement heat preservation irrigation during the reproductive phase, usually in mid-September. This leads to the most significant backscatter trough during the reproductive phase. Consequently, when the temperature in a specific area is not always above 10° C. throughout the year and a backscatter trough appears after September, the backscatter trough should be considered as corresponding to a potential rice reproductive phase. The other four rice phenological phases can then be calculated based on 30-day intervals. In all other scenarios, the backscatter trough should be regarded as corresponding to a potential rice transplanting phase, and the other four rice phenological phases can also be calculated using 30-day intervals.

A principle of the temperature limitation of rice phenological phase is as follows. The temperature conditions are critical for the survival and growth of rice plants. A minimum temperature of 10° C. is essential to ensure the survival of rice plants during all phenological phases of a rice planting cycle. Additionally, a minimum temperature of 18° C. is necessary for the effective accumulation of photosynthetic products during the vegetative and reproductive phases of a rice planting cycle. Therefore, after determining the phenological phase corresponding to the backscatter trough, it is essential to assess whether each phase meets the temperature requirements for rice growth. Only when the temperatures for all phenological phases meet the lower limit requirements can the backscatter trough be considered valid. Furthermore, when the number of valid backscatter troughs exceeds the maximum rice-crop intensity suitable for the target area, it indicates an overestimation of rice-crop intensity. The maximum rice-crop intensity suitable for the target area is determined by the duration of cold periods (<10° C.) throughout the year. Typically, a single rice planting cycle lasts 120 days in a field. The maximum rice-crop intensity suitable for the target area is as follows: When the duration of cold periods is 0, there is enough time for three rice planting cycles in a year, and the maximum suitable rice-crop intensity is 3. When the duration of cold periods is between 0 and 120 days, there is enough time for two rice planting cycles in a year, and the maximum suitable rice-crop intensity is 2. When the duration of cold periods is between 120 and 240 days, there is enough time for one rice planting cycle in a year, and the maximum suitable rice-crop intensity is 1. When the duration of cold periods exceeds 240 days, there is insufficient time for a complete rice planting cycle in a year, and the maximum suitable rice-crop intensity is 0. For target areas where there is an overestimation of rice-crop intensity, the difference between the number of valid troughs and the maximum rice-crop intensity suitable for the target area is calculated, representing the number of valid backscatter troughs that need to be removed. Since rice has higher temperature requirements compared to other land change processes, the temperature accumulation (i.e., the sum of temperature) in the potential phenological phases corresponding to the rice's backscatter troughs should be higher than that of other land change processes. Therefore, valid backscatter troughs with lower temperature accumulations need to be excluded.

A principle of identification of rice-crop intensity is as follows. Once the troughs corresponding to each rice planting cycle in the time series backscatter have been identified, it is essential to narrow down the area for rice-crop intensity assessment. The specific requirements of rice, such as a preference for a hot and humid climate, result in rice fields primarily being situated at altitudes below 1000 meters (m). Additionally, the need for water storage in rice fields means that they are typically located on slopes less steep than 5°. Moreover, the cropland area indicated in land use products serves as an indicator of potential rice field distribution. Therefore, by combining altitude, slope, and land use products, it becomes possible to further minimize the influence of backscatter fluctuations in non-rice areas on rice-crop intensity identification and enhance the accuracy of rice-crop intensity mapping.

In summary, in the disclosure, capturing the diverse periodic characteristics within time series backscatter data and detecting backscatter troughs through the processes of time series reconstruction and trough identification. It then determines rice phenology corresponding to these backscatter troughs using potential rice phenological phase estimation. By evaluating the temperature suitability of these potential rice phenological phases and considering the temperature limitations of rice growth phases, any backscatter trough that doesn't meet the required temperature conditions is removed. This process combines an understanding of rice growth mechanisms and regulation of rice-crop intensity, resulting in the identification of rice troughs and the correction of overestimation of rice-crop intensity. Ultimately, this leads to the identification of rice-crop intensity. The disclosure is well-suited for large-scale rice-crop intensity identification, addressing challenges posed by significant variations in natural and social conditions, complex and diverse farming practices, and the frequent interference of clouds and fog. This method effectively resolves three major issues encountered when identifying rice-crop intensity using radar data: the diversity in rice time series backscatter, the ambiguity in backscatter characteristics between rice and non-rice objects, and the problem of overestimating rice-crop intensity.

### BRIEF DESCRIPTION OF DRAWINGS

FIG. 1 illustrates a schematic flow diagram of a rice-crop intensity identification method based on radar time series observation and temperature analysis according an embodiment of the disclosure.

FIG. 2 illustrates a schematic diagram of time series reconstruction and trough identification according an embodiment of the disclosure.

FIG. 3 illustrates a schematic diagram of potential rice phenological phase estimation according an embodiment of the disclosure.

FIG. 4 illustrates a schematic diagram of temperature limitation of rice phenological phase according an embodiment of the disclosure.

FIGS. 5A-5C illustrate schematic diagrams of identification of rice-crop intensity according an embodiment of the disclosure.

### DETAILED DESCRIPTION OF EMBODIMENTS

The disclosure will be further described in detail hereinafter in combination with the accompanying drawings and specific embodiments.

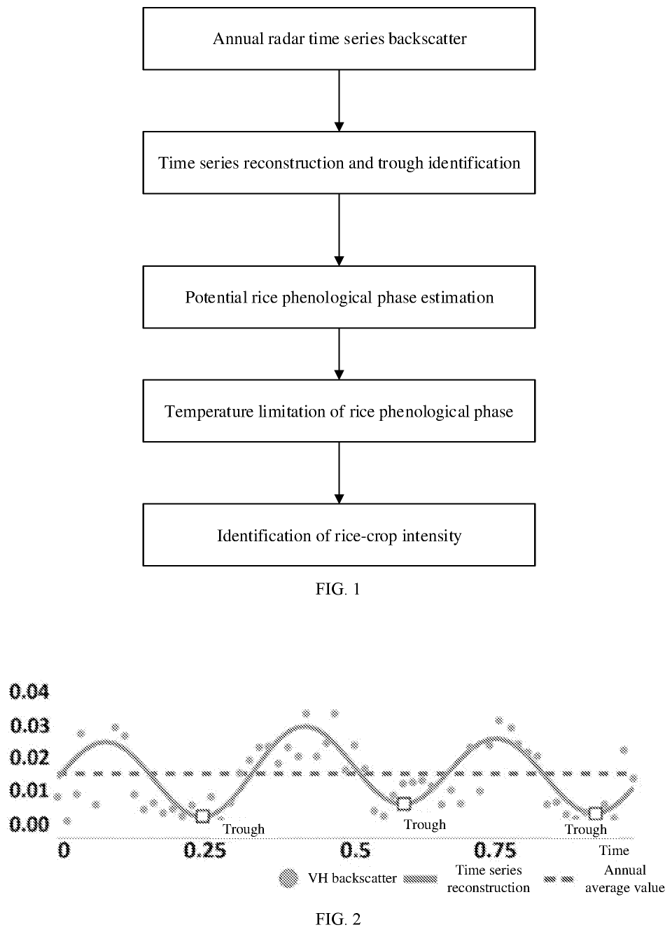

A rice-crop intensity identification method based on radar time series observation and temperature analysis is provided (as shown in FIG. 1), a development environment of the disclosure is Google earth engine (GEE), and a programming language thereof is JavaScript. The rice-crop intensity identification method based on radar time series observation and temperature analysis includes steps 1 to 4.

The step 1 includes: retrieving VH polarization data of Sentinel-1 (i.e., a radar) in Leizhou City, Guangdong Province in the year of 2020; using an imageCollection function to construct time series backscatter; using an image.linearRegression function to realize time series harmonic fitting, so as to obtain undetermined coefficients a, Aᵢ, and φᵢ to reconstruct the time series backscatter; using a mathematical operation library of the GEE to calculate a first-order difference of the reconstructed time series backscatter; and using a logical operation library of the GEE to identify a backscatter trough and extract the actual Julian date d corresponding to the backscatter trough.

The step 2 includes: retrieving annual daily averaged temperature data from ERA5-Land (which is a meteorological data set) in Leizhou City, Guangdong Province in the year of 2020; counting the duration of P_{C} corresponding to a temperature being below 10° C.; determining a potential rice phenology phase corresponding to the backscatter trough according to the values of P_{C} and d, and obtaining the remaining phenology phases at intervals of 30 days to thereby obtain D_{S}, D_{T}, D_{V}, D_{R} and D_{M}.

The step 3 includes: calculating temperature E_{S}, E_{T}, E_{V}, E_{R} and E_{M} of phenological phases by using a Filter.date function and a reduce (‘mean’) function; determining whether a temperature of each phenological phase satisfies a growth requirement of rice by using the logic operation library of the GEE; removing any backscatter trough not satisfying a temperature condition, and the remaining backscatter trough is a valid backscatter trough; using the logic operation library of the GEE to calculate a maximum rice-crop intensity S capable of being achieved by each region; in a situation that the number of valid backscatter troughs N is greater than S, calculating a sum Sum of temperature on phenological phases corresponding to each valid backscatter trough; removing N−S valid backscatter troughs with lower Sum; and determining the remaining valid backscatter trough as a rice troughs; in a situation that N is not greater than S, determining all valid troughs as the rice troughs.

The step 4 includes: retrieving an altitude and a slope from NASADEM; retrieving cropland distribution information from ESA WorldCover; using the mathematical operation library of the GEE to extract the cropland with an altitude below 1000 m and a slope below 5°; counting the number of rice troughs in different positions in the cropland, thereby realizing the identification of rice-crop intensity.

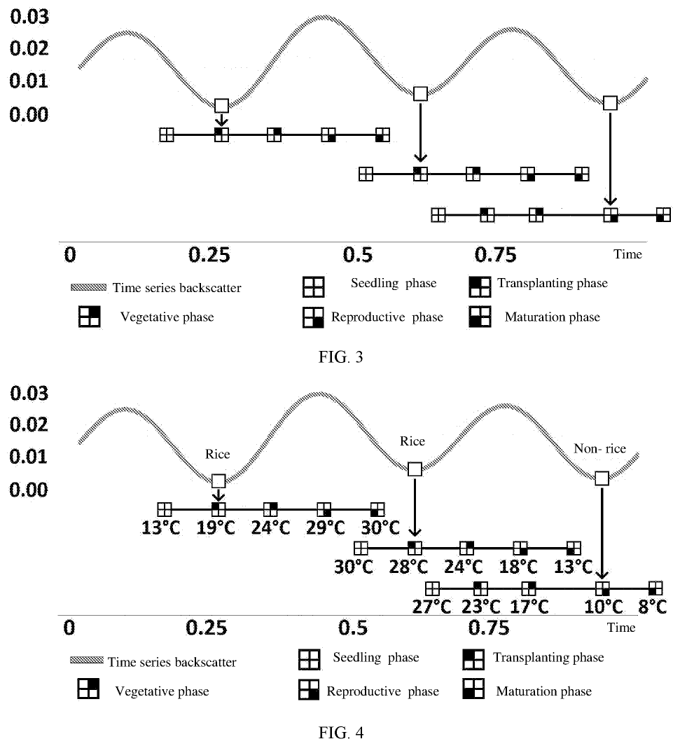

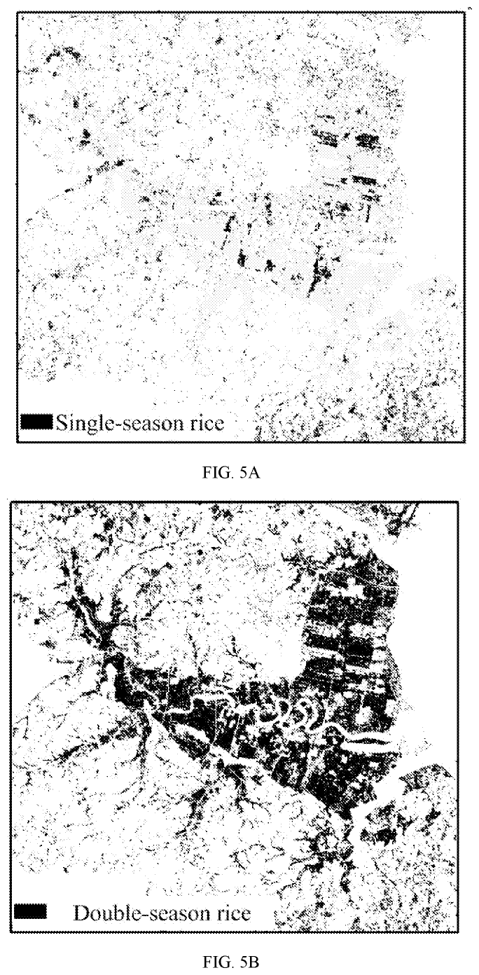

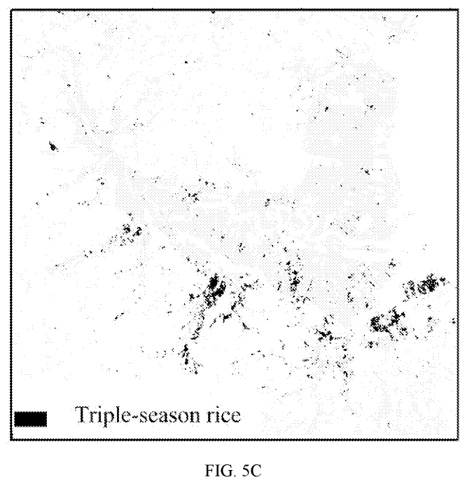

In the disclosure, the time series radar data of Sentinel-1, the temperature data of ERA5-Land, and data of NASADEM and ESA WorldCover are processed. FIG. 2 illustrates a schematic diagram of time series reconstruction and trough identification according an embodiment of the disclosure. FIG. 3 illustrates a schematic diagram of potential rice phenological phase estimation according an embodiment of the disclosure. FIG. 4 illustrates a schematic diagram of temperature limitation of rice phenological phase according an embodiment of the disclosure. FIGS. 5A-5C illustrate schematic diagrams of identification of rice-crop intensity according an embodiment of the disclosure.

As can be seen from the above embodiments, the disclosure realizes the identification of rice-crop intensity in Leizhou City, Guangdong Province in the year of 2020, and an accuracy thereof reaches to 79.25%. The method provided by the disclosure effectively captures the characteristics of time series backscatter period and potential rice backscatter attenuation, determines the timing of the key phenological phase of a potential rice planting cycle, evaluates the temperature suitability of potential rice phenology, combines the rice growth mechanism and the regulation of rice-crop intensity to identify the rice troughs and correct the overestimation of the rice-crop intensity, achieves the rice-crop intensity identification under a condition of obvious differences in natural and social conditions, complex and diverse farming practices and frequent meteorological interference of clouds and fog, promotes the application of radar data in large-scale rice-crop intensity identification, and provides information support for food security and social stability.

What is claimed is:

1. A rice-crop intensity identification method based on radar time series observation and temperature analysis, comprising:
S1, time series reconstruction and trough identification:
obtaining annual radar time series backscatter data of a target area in vertical transmission and horizontal reception (VH) polarization;
constructing time series backscatter S[t] based on the annual radar time series backscatter data, where t represents a normalized Julian date, and a value of t ranges from 0 to 1;
performing time series harmonic fitting by using a formula 1 to obtain reconstructed time series backscatter:
$$S [ t ] = a + {\sum }_{i = 1}^{3} {A}_{i} cos [ 2 π it - {φ}_{i} ] , \qquad ( formula 1 )$$
where a is a constant term representing an average value of the time series backscatter S[t]; i takes values 1, 2, and 3 successively, indicating an order of a cosine term; Aᵢ represents an amplitude of an i-th order cosine term, and φᵢ represents a phase of the i-th order cosine term; the process of performing time series harmonic fitting by using the formula 1 to obtain the reconstructed time series backscatter comprises: obtaining values of a, Aᵢ, and φᵢ by using least square fitting, and substituting the values of a, Aᵢ and φᵢ into the formula 1 to obtain the reconstructed time series backscatter;
obtaining a first-order difference S′[t] of the reconstructed time series backscatter using a formula 2:
$${S}^{′} [ t ] = {\sum }_{i = 1}^{3} - 2 π {iA}_{i} sin [ 2 π it - {φ}_{i} ] ; \qquad ( formula 2 )$$
and
calculating values of S[t] and S′[t] for the normalized Julian date t in the range from 0 to 1 with a step size of 0.01; and when S′[t−1]<0, S′[t+1]>0, and S[t]<0.02, determining that the normalized Julian date t corresponds to the occurrence of a backscatter trough, wherein an actual Julian date d corresponding to the normalized Julian date t is calculated as d=365t, where the unit of d is in days;
S2, potential rice phenological phase estimation:
representing five phenological phases composed of a seedling phase, a transplanting phase, a vegetative phase, a reproductive phase, and a maturation phase, as D_{S}, D_{T}, D_{V}; D_{R} and D_{M}, respectively; obtaining annual daily averaged temperature data of the target area; calculating a duration of an annual cold period P_{C} of the target area based on the annual daily averaged temperature data, where P_{C} is defined as a period with temperatures below 10 degrees Celsius (° C.), and the unit of P_{C} is in days; for the target area, when P_{C}≠0, and d>240, determining that d corresponds to D_{R}, and in this case, determining that D_{S}=d−90, D_{T}=d−60, D_{V}=d−30, D_{R}=d, and D_{M}1=d+30; and when P_{C}=0 or d≤240, determining that d corresponds to D_{T}, and in this case, determining D_{S}=d−30, D_{T}=d, D_{V}=d+30, D_{R}=d+60, and D_{M}=d+90; and
S3, temperature limitation of rice phenological phase:
obtaining a temperature E_{S} corresponding to D_{S}, a temperature E_{T} corresponding to D_{T}, a temperature E_{V} corresponding to D_{V}; a temperature E_{R} corresponding to D_{R}, and a temperature E_{M} corresponding to D_{M}, respectively;
for a target backscatter trough, when E_{S}>10° C., E_{T}>10° C., E_{V}>18° C., E_{R}>18° C., and E_{M}>10° C., determining the target backscatter trough as a valid trough, otherwise determining the target backscatter trough as an invalid trough and removing the invalid trough; counting the number N of valid troughs;
determining a maximum rice-crop intensity suitability S for the target area according to the following regulation:
$$\{ \begin{matrix}if Pc = 0 , then S = 3 ; \\ if 0 < Pc \leq 120 , then S = 2 ; \\ if 120 < Pc \leq 240 , then S = 1 ; \\ if Pc > 2 \; 40 , then S = 0 .\end{matrix} ;$$
and
for the target area, when N>S, determining that there is overestimation of rice-crop intensity; calculating a sum value Sum of the temperatures on the five phenological phases for each valid trough: Sum-E_{S}+E_{T}+E_{V}+E_{R}+E_{M}; removing troughs with a lower Sum, where the number of troughs to be removed is N−S; and determining the remaining troughs as rice troughs and counting the number of rice troughs of the target area, which is a rice-crop intensity of the target area; and when N≤S, determining the number N of valid troughs as the number of rice troughs of the target area, which is a rice-crop intensity of the target area; and
S4, identification of rice-crop intensity:
obtaining digital elevation data of the target area, and extracting altitude and slope information of the target area from the digital elevation data; obtaining land use product of the target area, and extracting cropland distribution information from the land use product; and performing rice-crop intensity identification of the target area based on the altitude and slope information, the cropland distribution information, and the number of rice troughs of the target area.

2. The rice-crop intensity identification method based on radar time series observation and temperature analysis as claimed in claim 1, wherein in S4, a threshold condition for the extracting the altitude and slope information is reserving a cropland with an altitude below 1000 meters (m) and a slope below 5°.

3. The rice-crop intensity identification method based on radar time series observation and temperature analysis as claimed in claim 1, wherein in S1, the time series backscatter is constructed by using an imageCollection function, and the time series harmonic fitting is realized by using an image.linearRegression function.

4. The rice-crop intensity identification method based on radar time series observation and temperature analysis as claimed in claim 2, the performing identification of rice-crop intensity of the target area based on the altitude and slope information, the cropland distribution information, and the number of rice troughs of the target area, comprises:
presenting the number of rice troughs of the target area corresponding to the cropland based on the altitude and slope information and the cropland distribution information.

5. The rice-crop intensity identification method based on radar time series observation and temperature analysis as claimed in claim 1, further comprising:
estimating a yield of the target area based on the number of rice troughs of the target area, and thereby, facilitating agricultural management personnel to craft agricultural policies grounded in the yield of the target area.

6. The rice-crop intensity identification method based on radar time series observation and temperature analysis as claimed in claim 1, wherein the rice-crop intensity identification method based on radar time series observation and temperature analysis is implemented by a rice-crop intensity identification device comprising a processor and a memory with a rice-crop intensity identification application stored therein; the rice-crop intensity identification application, when executed by the processor, is configured to implement the rice-crop intensity identification method based on radar time series observation and temperature analysis and is further configured to send, over the Internet, the number of rice troughs of the target area to a mobile terminal of agricultural management personnel; and an application installed in the mobile terminal is configured to: receive the number of rice troughs of the target area, and display the number of rice troughs of the target area on the mobile terminal to assist the agricultural management personnel to estimate a yield of the target area and formulate agricultural policy based on the yield of the target area.
